(19) United States
(12) Patent Application Publication
(10) Pub. No.: US 2008/0171200 A1
(43) Pub. Date: Jul. 17, 2008

(54) Concentrated Reinforcing Bars And Method For Making Same

(76) Inventors: Philippe Pardo, Bassens (FR); Christophe Ducret, Le Passage (FR); Guy Zanella, Cognin (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/817,834

(22) PCT Filed: Jan. 24, 2006
(86) PCT No.: PCT/FR06/50049

§ 371 Date: Sep. 5, 2007

(30) Foreign Application Priority Data
Mar. 9, 2005 (FR) 0550618

(51) Int. Cl. B32B 5/10; B27N 3/08

(52) U.S. Cl. 428/364; 264/257

(57) ABSTRACT

A process for manufacturing rods of reinforcement concentrates, a device for implementing the process, and products obtained. The method includes heating and shaping at least one bundle of strands having more than 70% by weight of reinforcing material and a moisture content of at least 0.1% before being cut up into rods.

The present invention relates to a process for manufacturing rods (small rods or sticks) of reinforcement concentrates (or concentrated reinforcements) used especially for manufacturing composite products by molding (in particular by injection molding, extrusion-compression molding, comolding, etc.) and it also relates to the products obtained.

In the aforementioned molding processes (especially by injection molding or extrusion-compression molding), it is general practice to use compounds (or mixtures) consisting of organic material, fibrous reinforcements (such as glass strands) and one or more additives (for example for coloring or providing particular functions). The compound may be formed directly in an extruder or in an injection molding machine using reinforcement strands, which may or may not be already coated with organic material, which strands are generally already chopped in order to make metering and compounding easier, the other optional components being, where appropriate, added in the extruder or in the molding machine.

The inventors have sought to develop a reinforcements-based product that can be used advantageously in these molding processes, it being possible for the desired advantages to be one or other of the following advantages: cost saving, better preservation of the reinforcements (for example the length of the reinforcement strands) for better mechanical properties, better dispersion during molding, easier adaptation according to the products desired, easier processing, etc.

In this search, the inventors emphasized the benefit of developing products in the form of reinforcements concentrated rods (or granules or pellets), it being possible for these products to provide various advantages as will be especially explained later, and have thus sought a process allowing these products to be manufactured easily, it not being possible hitherto to obtain such concentrated products in a simple and efficient manner starting from conventional reinforcements, since the increase in reinforcement(s) content may in particular result in problems of lack of integrity of the products produced or poor dispersion of these products in the molding matrices.

The present invention therefore relates in the first place to a process for manufacturing concentrate rods in which at least one bundle of strands having more than 70% by weight of reinforcing material(s) and a moisture content of at least 0.1% by weight is heated and shaped before being cut into rods.

The rods obtained comprise a reinforcing material essentially in the form of strands or filaments (cut to the length of the rod) that are advantageously bonded together by at least one organic material, as will be explained subsequently.

The present invention also relates to the rods of reinforcement concentrates (or reinforcement strands in rod form) developed and obtained in particular by the above process. These rods have a content of reinforcing material(s) of greater than 65% and preferably greater than 70% (or even at least 80%) by weight. These reinforcements are bonded together or embedded in at least a first organic material and, as the case may be, they are sheathed with at least a second material, generally at least one organic material, as will be explained later, it being possible for the two organic materials to be the same or different.

The bundle of strands mentioned according to the invention comprises at least one reinforcing material (glass, carbon, aramid, etc., this material preferably being glass) in the form of at least some of said strands or in the form of filaments (generally obtained in a known manner by attenuating this material beneath a bushing or die, these filaments then being assembled into strands) forming at least some of said strands, the content of reinforcing material(s) within the bundle being more than 70% by weight according to the invention and preferably ranging from 75 to 99% by weight, or even 80 to 95% by weight.

Preferably, at least some of the strands used also comprise at least one thermoplastic organic material, this material being for example chosen from polyolefins, especially polyethylene (PE), polypropylene (PP), polyesters, especially polyethylene terephthalate (PET), polybutylene terephthalate (PBT), elastomers, especially an ethylene propylene polymer (EPDM) or polyvinyl chloride (PVC), or polyamides, etc. Advantageously, this material is also present in the bundle in the form of strands or filaments.

In particular, and preferably, at least some of the strands used in the process according to the invention are composite strands (or comingled strands), formed from reinforcement filaments (especially glass filaments) and from filaments of at least one thermoplastic organic material, advantageously these filaments being intimately blended, the intimate structure of these strands making it easier for the glass fibers to be impregnated with the thermoplastic material and, in the process according to the invention, making it possible to form, despite the high reinforcement content, a consolidated structure (that is to say one exhibiting cohesion and integrity allowing it to be handled without damage) which is well impregnated and homogeneous. Advantageous composite strands (such as those sold under the brand name TWINTEX® by Saint-Gobain Vetrotex France) may be obtained by a direct process, such as that described in patents EP 0 367 661, WO 98/01751 or EP 0 599 695, these strands having an excellent comingling index leading to excellent distribution of the glass strands within the thermoplastic material, as explained in patent application WO 00/24566.

Particularly preferably, the process according to the invention uses, as strands forming the bundle, only composite strands. However, it is not excluded in particular to combine composite strands with reinforcement strands so as to further increase the reinforcement concentration of the rods.

In combination with the high reinforcement content, favored in particular by the preferential use of composite strands as mentioned above, the inventors have also demonstrated, as is apparent from the definition of the invention, the benefit of using a bundle having a moisture content (water content measured for example by evaporation in an oven) of at least 0.1%, preferably at least 0.5% and particularly preferably at least 3% by weight. The presence of a certain amount of moisture, far from impairing the processing and the properties of the products obtained, actually allows the strands to be easily handled in the rod manufacturing process according to the invention, while still allowing products to be obtained that exhibit mechanical properties at least as good if not better than those of the products obtained from pre-dried strands, and still providing an economic advantage (it is especially possible for the strands obtained or collected beneath a bushing to be used directly without an expensive intermediate drying step). Preferably, the moisture content is also chosen to be less than 8%, advantageously less than 5%, by weight so as in particular to allow good consolidation of the strands and of the bundle in the process according to the invention.

The strands may be formed beforehand or extracted individually or in groups, from at least one wound package. According to a preferred method of implementation of the invention, they are extracted from at least a wound package, such as a roving, and are driven at a speed of at least 10 m/min., preferably at several tens of m/min., especially around 40 to 100 m/min., and in particular around 50 m/min., for example by means of a pulling device (which may especially be a pulling rig).

It may be advantageous to provide a step in which the tension of the strands is regulated (for example during their assembly into one or more bundles or before their assembly) and/or the strands may be stripped of any static electricity, for example before passing the bundle through the heating zone.

The strands are assembled in the form of at least a bundle as mentioned in the process according to the invention. It goes without saying that it is also possible to form several separate bundles that undergo in parallel the same treatment or different treatments, at least one of which undergoing the steps indicated in the process according to the invention in order to obtain the concentrate rods.

According to the invention, at least one bundle is heated (generally by passing it through at least one heater, such as an infrared oven) at a temperature allowing it to be formed and/or consolidated, and making it possible, where appropriate, to impregnate the reinforcement strands or filaments with the organic material, in particular at a temperature that reaches at least the melting point of the thermoplastic material present within the bundle of strands and preferably at least 20° C. above said melting point of the thermoplastic material, this temperature remaining however below the decomposition temperature of said material and below the melting point of the reinforcing material.

In general, the heated bundle of strands is maintained approximately at temperature until its conformation (or shaping or sizing), the shaping operation advantageously taking place by passing through one or preferably several sizing dies so as to obtain the desired cross section. In the process according to the invention, and so that the production line has a satisfactory efficiency, especially in combination with the abovementioned drive speeds, the dies chosen advantageously have simple profile(s) along the direction of the production line and decreasing cross section(s).

During and/or after heating, and prior to and/or jointly with the aforementioned shaping operation, the bundle may also, where appropriate, undergo a step that favors impregnation of the reinforcement strands or filaments with the organic material present, by passing through a device such as one or more bars. Several of these devices may be used, a first one being placed for example between two heaters in the heating step according to the invention and the other being placed just after the shaping die or dies.

The aforementioned shaping and impregnation step or steps promote the formation of a consolidated bundle (or impregnated or integrated bundle, that is to say one in which the strands are bonded together, this consolidated bundle also being denoted by the term strand assembly or tow according to the invention, or even a cable or rope).

According to one particularly preferred method of implementing the invention, during or following the shaping operation, the bundle of strands also undergoes a sheathing step by passing through a die also fed with at least one organic material in the melt state, this material possibly being identical or different to the organic material forming the strands. The sheathing material may also be composite, formed from several materials, in particular from at least one organic material and additive(s) (for example an additive for improving the ultraviolet radiation resistance, a coupling agent for increasing the mechanical performance, a thermal or chemical stabilizer, a dye or pigment, a flame retarder, etc.) and/or one or more fillers (talc, glass fibers, whether short or long, etc.). Thus, the sheathing material may advantageous allow the rods obtained, and the composites molded from these rods, to be given additional properties (anti-UV properties, improved mechanical performance, etc.). The fact of having products that are already functionalized also makes it possible, during molding, to use only inexpensive standard diluting materials, thereby simplifying and reducing the cost of the molding. The sheathing also prevents the formation of fibrils or fines (fibers detached from the rod) during cutting into rods, which fibrils may pose conveying problems or congestion problems of the injection molding equipment during molding (and may damage the conveying systems or said injection molding equipment), and may impair the mechanical properties of the products obtained. The sheathed rods are also able to be very easily handled, metered and transported along supply hoses, as the rods are smoothed by the sheath, the sheath also acting as protection, and they do not lose their integrity up to the point in which they are used to form composites by molding. Finally, the sheathing makes it possible to adjust as required the reinforcement content, by varying, in line (during manufacture), the quantity of sheathing material delivered and thus it makes it possible to obtain rods with various reinforcement concentrations from a starting product that may advantageously not vary.

Preferably, the sheathing material comprises at least one thermoplastic organic material, for example a polyolefin (especially polyethylene or polypropylene) or polyvinyl chloride, or an elastomer, for example an SEBS (styrene ethylene butadiene styrene)-modified polypropylene, etc. Where appropriate, this material is advantageously chosen to be identical or similar to, or chemically compatible with, the organic material of the strands (so that there is good adhesion, or even continuity, between the two materials), it being possible for this material to be filled with additives, as mentioned above.

The sheathing material introduced into the die may come for example from an extrusion device. The bundle may also be coated with several identical or different materials feeding the die (or, where appropriate, several dies in series or in parallel), this method of operation also making it possible to extend the range of products obtained. When several bundles are treated in parallel, the sheathing material may, where appropriate, vary from one bundle to another. The thickness of the sheath may vary; for example, for a rod around 3 mm in thickness, the sheath may be around 0.1 mm or one tenth of the thickness of the rod, or more.

After shaping and optional sheathing, the bundle obtained is generally cooled (for example by passing it through a water tank or a cold die), where appropriate dried (by blowing or suction) and then cut or chopped (for example using a milling cutter or granulator with rotating blades) into rods, having a length generally between 1 and 40 mm, preferably between 5 and 30 mm, for example around 12 mm.

As explained above, the process and the products according to the invention have the advantage of being adaptable without changing the starting products. Furthermore, the process according to the invention is easily and rapidly implemented and is inexpensive.

The rods according to the invention have a high content of reinforcement as defined above, while being integrated and where appropriate well impregnated, and, as mentioned above, they may have a sheath. Advantageously, these rods (particularly when sheathed) have a fibril content of less than 60, preferably less than 30 and particularly preferably less than 20 mg per kg of rods (this content being measured by making the rods vibrate on a belt and sucking up the fibrils by means of a suction device provided with a filter). They are easy to handle and to meter, being well dispersed in an organic matrix during molding despite the high reinforcement content. The rods according to the invention generally have the length of the reinforcement strands between 1 and 40 mm, preferably between 5 and 30 mm, for example around 12 mm.

The present invention also relates to a device for implementing an advantageous method of carrying out the aforementioned process. This device includes one or more means for providing at least one bundle of strands, at least one means for heating said bundle, at least one shaping device, at least one sheathing die, fed with at least one melt material and having to receive simultaneously the bundle of strands and the melt material in contact with said bundle, and at least one cutting device, for cutting the sheathed bundle into rods.

The device may also include (in combination with or as a complement to the above means) one or more of the following means, in particular:
at least one pulley for guiding the strands;
one or more means for driving the strands;
one or more means for assembling the strands into the form of a least one bundle of parallel strands (for example means of the eyelet-plate and/or grooved-pulley and/or spreader-bar type);
one or more strand tension regulators, for example upstream of the aforementioned assembling means;
one or more means for keeping the bundle or tow at a temperature, where appropriate right up to at least the die;
one or more additional impregnation devices, especially before the shaping device;
one or more bundle positioning means; etc.

Most of these devices have already been mentioned previously.

In particular, the strands may come from packages, which may be placed on a creel from which the strands are unwound.

The one or more heating means generally comprise one or more ovens, for example of the infrared type, preferably operating with power-regulated lamps depending on the temperature of the bundle, this kind of oven having the advantage of being both effective from the energy standpoint and easy to regulate.

As impregnation device, it is possible to use for example a device having three members arranged in a triangle, between which the bundle runs, the distance separating the members being adapted in order to obtain appropriate pressure on the surface of the bundle, these members possibly being rolls or bars.

The actual shaping devices may for example include a heated die and/or rollers between which the strand bundle runs, etc. As indicated above, the dies used advantageously have a simple profile with a cross section, for example, varying progressively (for example decreasing in cross section) then being constant depending on the position, about an axis parallel to the direction of the manufacturing line.

The sheathing die may also include one or more means for supplying the sheathing material while pressurizing it. Said material may come into contact with the strand assembly via different channels in the die. Depending on the cross section of the die and/or the presence of various channels and/or the pressurization and/or the position of the bundle in the die, the quantity of material(s) delivered may be different at various points along the cross section of the bundle.

The molten sheathing material generally comes from at least one extruder.

The cutting device may for example be a granulator or a milling cutter, as mentioned above.

The various elements of the device according to the invention may be stationary or possibly moving (translationally and/or rotationally).

The invention also relates to a composite product obtained, by molding, from the rods according to the invention. The rods according to the invention make it possible to obtain, at high production rates, complex parts (including, where appropriate, ribs, bosses, etc.) presenting a satisfactory distribution of the reinforcing material, the composites obtained from these rods also having good mechanical properties.

The composites obtained from the rods according to the invention may for example be motor vehicle body parts, such as front panels, dashboards, door modules, under-engine protection plates, inner panels for hatchbacks, etc.

1-7. (canceled)

8. A process for manufacturing rods of reinforcement concentrates, comprising:
heating and shaping at least one bundle of strands having more than 70% by weight of reinforcing material and a moisture content of at least 0.1% before being cut up into rods.

9. The process as claimed in claim 8, wherein at least some of the strands are composite strands formed from reinforcement filaments, or glass filaments, and filaments of at least one thermoplastic organic material.

10. The process as claimed in claim 8, wherein:
the bundle of strands furthermore undergoes a sheathing by passing through a die fed with at least one organic material, or with at least one organic material and at least one additive.

11. A device for implementing the process as claimed in claim 10, comprising:
one or more means for providing at least one bundle of strands;
at least one means for heating the bundle;
at least one shaping device;
at least one sheathing die; and
at least one cutting device.

12. A reinforcement concentrated rod having a reinforcement content of greater than 65% by weight, reinforcements being bonded together or embedded in at least a first organic material sheathed with at least a second material.

13. The rod as claimed in claim 12, having a fibril content of less than 60 mg/kg.

14. A composite obtained by molding using rods as claimed in claim 12.
